(19) United States
(12) Patent Application Publication
(10) Pub. No.: US 2007/0188457 A1
(43) Pub. Date: Aug. 16, 2007

(54) Optical mouse system with illumination guide having a light spreading lens

(75) Inventors: Rong Yaw Wu, Hsien-Tien City (TW); Shu Ying Cheng, Hsien-Tien City (TW); Shih Che Chen, Hsien-Tien City (TW)

Correspondence Address: HDSL, 4331 STEVENS BATTLE LANE, FAIRFAX, VA, 22033, US

(73) Assignee: Pixon Technologies Corp.

(21) Appl. No.: 11/354,022

(22) Filed: Feb. 15, 2006

(51) Int. Cl. G09G 5/08

(52) U.S. Cl. 345/166

(57) ABSTRACT

An optical mouse system with an illumination guide includes a concave lens for spreading light to create a uniform, low contrast, illumination pattern. The uniform illumination pattern increases the accuracy of mouse movement detected by the sensor. The illumination source and optical sensor are mounted in the same plane, directly on the PCB. The higher angle of the optical path causes more light to be reflected to the optical sensor, increasing optical efficiency and allowing a smaller, lower powered LED to be used. This also results in increased sensitivity of the optical sensor. Lower power usage increases battery life for mobile or wireless-mouse use, while reducing thermal waste considerations. This allows the creation of a significantly smaller form factor for the overall package, thereby reducing materials costs and giving designers more flexibility for external design considerations.

### BACKGROUND OF THE INVENTION

1. Field of the Invention

The present invention relates to optics. More specifically, the present invention discloses an optimized optical system comprising an optical mouse illumination guide with a concave lens for spreading light to create a uniform, low contrast, illumination pattern.

2. Description of the Prior Art

Traditionally, an optical computer mouse uses a light-emitting diode (LED) to graze a surface with illuminating light, and detects patterns in reflected light from the surface to compute motion.

Please refer to FIG. 1a, a diagram of a prior-art optical computer mouse 100. Externally, the mouse has a housing 101 and a base plate 102. Internal to the housing, a printed-circuit board (PCB) 110 has a light-emitting diode 140 (LED) and optical sensor 150 mounted to it. The LED 140 emits light, a light beam 170 of which is focused and guided through an illumination guide 130. The illumination guide 130 typically extends through a hole in the PCB 110.

The light beam 170 enters the illumination guide 130 through a first flat surface 1311, is reflected off a first reflector 1301, is reflected off a second reflector 1302, and exits the illumination guide 130 through a second flat surface 1312. The light beam 170 exits the mouse body through an aperture 107 in the base plate 102, reflects off a reference surface 10, and reenters the illumination guide 130 through a third flat surface 1313.

The light beam 170 shines onto an optical sensor 150, which detects patterns in the reference surface 10 revealed by the light. These patterns may be caused by roughness in the reference surface 10, or may be caused by colorations of the surface 10.

Referring to FIG. 1b, the angle 20 between the light beam 170 and the reference surface 10 is acute and is typically less than about twenty degrees and greater than about five degrees from the plane of the reference surface. The angle 70 between the light beam 170 and a normal 90 to the reference surface 10 is thus typically about seventy degrees or greater.

However, this low angle causes most of the light emitted by the LED to have an uneven illumination pattern, thereby causing problems for the sensor. For example, some areas of the illumination pattern are very bright, whereas other areas a dim. The LED 140 must therefore be of high intensity in order to overcompensate for the dim areas, thereby consuming a large amount of power, which is then wasted on generating lost light, and which also creates heat dissipation issues.

Furthermore, this requires the LED 140 and other components to be correspondingly large, increasing the size of the mouse. In addition to increasing materials costs, this creates a lower limit on the attainable size of the mouse.

Moreover, the structure of this design places the LED 140 and the optical sensor 150 in different planes, and requires cuts in the PCB 110, thereby further increasing the design complexity of the mouse, and also increasing the required size.

In addition, the structure of the prior art mouse is typically open internally, and in many cases transparent materials are used for the housing 101 and base plate 102 for aesthetic considerations, thereby allowing external light not generated by the mouse 100 to reach the optical sensor 150, and internally, allowing randomly scattered light from the LED 140 to reach the optical sensor 150. This undesirable light can only serve to interfere with the imaging performed by the optical sensor 150.

Therefore there is need for an improved optical system for the mouse which will allow smaller overall size and lower power consumption while also reducing design complexity.

### SUMMARY OF THE INVENTION

To achieve these and other advantages and in order to overcome the disadvantages of the conventional method in accordance with the purpose of the invention as embodied and broadly described herein, the present invention provides an optical mouse system that directs illumination at a surface from an angle of typically less than about thirty-three degrees in respect to a 90 degree angle from the surface, thereby increasing the optical efficiency of the system and reducing power requirements, and also thereby increasing the sensitivity of the system to the relative movement of the reference surface, and also thereby shrinking size requirements.

The present invention provides an optimized optical system with a concave surface for a lens for sensing motion of a surface relative to the optical system. The concave surface is situated on the illumination guide where the illumination beam exits the mouse to be reflected by a reference surface. Instead of focusing light in order to create a high intensity, high contrast illumination pattern, the present invention spreads the light to create a uniform, low contrast, illumination pattern.

When light passes through a convex lens, the convex lens causes light rays to refract convergently. This therefore creates a light pattern that is focused into a small point of light. This compact, high contrast, light pattern creates problems for the sensor and can cause the sensor to misinterpret motion of the mouse.

However, a concave surface causes light rays to refract divergently. As a result, the light is spread and creates a uniform and low contrast illumination pattern. This allows the sensor to more accurately sense motion of the mouse. As a result, the cursor representing mouse position moves across the screen more accurately and smoothly. As a result, computer user satisfaction is increased.

The present invention further provides an optical mouse system in which the illumination source is mounted on the same surface or plane as the optical sensor, thereby simplifying construction and shrinking size requirements.

The present invention further provides an optical mouse system in which the optical sensor may optionally be substantially isolated from extraneous light, both that which is generated by the mouse and that which is foreign to the system, thereby increasing the sensitivity of the system to the relative movement of the reference surface.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1a is a diagram showing a cross section of a prior art optical computer mouse;

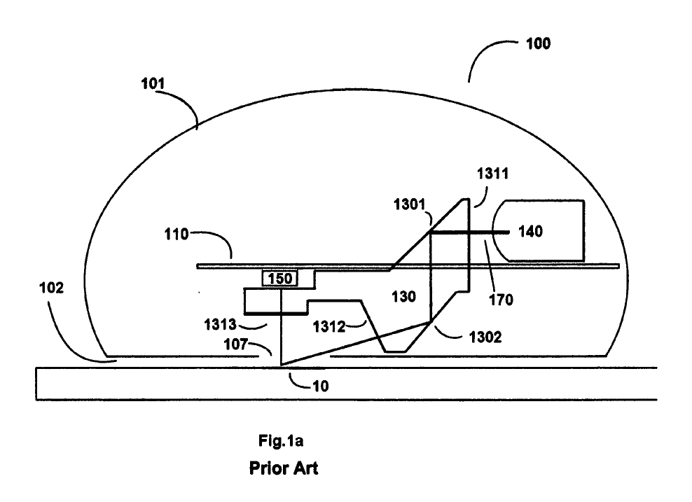

FIG. 1b is a diagram illustrating the path of a light beam generated by a prior art mouse;

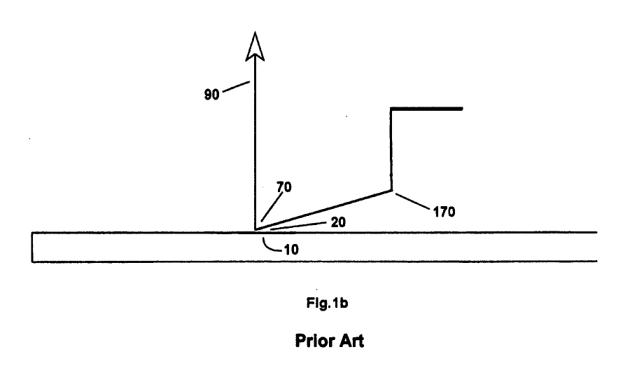

FIG. 2a is a sectional diagram illustrating internal components of an optical computer mouse according to an embodiment of the present invention;

FIG. 2b is a sectional diagram illustrating internal components of an optical computer mouse according to an embodiment of the present invention;

FIG. 3a is a detail diagram illustrating an illumination guide of an optical computer mouse according to an embodiment of the present invention;

FIG. 3b is an drawing illustrating an illumination guide of an optical computer mouse according to an embodiment of the present invention;

FIG. 4 is a diagram of the illumination pattern of an illumination guide for an optical mouse according to an embodiment of the present invention;

FIG. 5 is a diagram of the illumination pattern of an illumination guide for an optical mouse according to an embodiment of the present invention; and

FIG. 6 is a diagram illustrating an illuminance map of the optics for an optical mouse according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

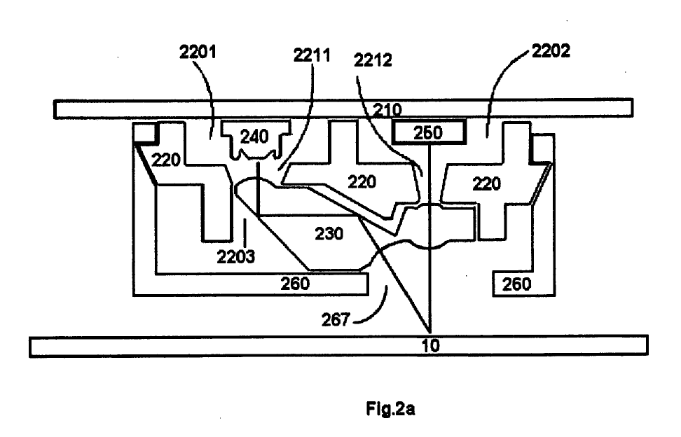

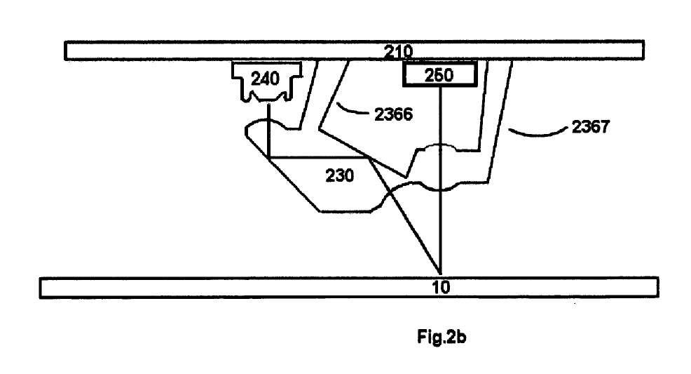

Please refer to FIG. 2a, which shows a cross-section diagram of the internal components of an optical computer mouse according to an embodiment of the present invention. The cross-section traverses the exit aperture 2211 and entry aperture 2212, thereby causing the holder 220 to appear as if in three pieces.

An illumination source 240 and an optical sensor 250 are mounted on a printed-circuit board (PCB) 210. The illumination source 240 is typically a light-emitting diode (LED) in the SMD form factor, but the present invention may also use an infrared-emitting diode, a laser diode, or other suitable illuminating radiation emission source matched to the type of illumination that the optical sensor 250 can receive.

A holder 220 is disposed over and around the illumination source 240, such that the holder 220 in combination with the PCB 210 isolates the illumination source 240 inside a source cavity 2201 so that the illumination it generates only exits through an exit aperture 2211. Likewise, the holder 220 is disposed over and around the optical sensor 250, such that the holder 220 in combination with the PCB 210 surrounds the optical sensor 250, isolating the optical sensor 250 inside a sensor cavity 2202 so that the illumination the optical sensor 250 receives, only enters through an entry aperture 2212.

An illumination guide 230 rests in an illumination guide cavity 2203 of the holder 220, retained securely in place by a clip 260. The clip 260 has a main aperture 267 through which the illumination exits, reflects off a reference surface 10, and re-enters the optical computer mouse.

Refer to FIG. 2b, which shows a cross-section diagram of the internal components of an optical computer mouse according to an embodiment of the present invention. This embodiment differs from the previous embodiment in that it does not use a holder to isolate the illumination source 240 from the optical sensor 250. The illumination guide may be held to the PCB 210 by a clip (not shown) or integrated fingers 2366˜2367, or it may be attached to the housing (not shown) or the housing base (not shown), or it may be an integral part of the housing base (not shown).

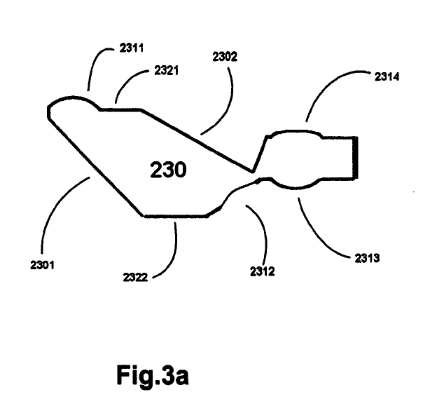

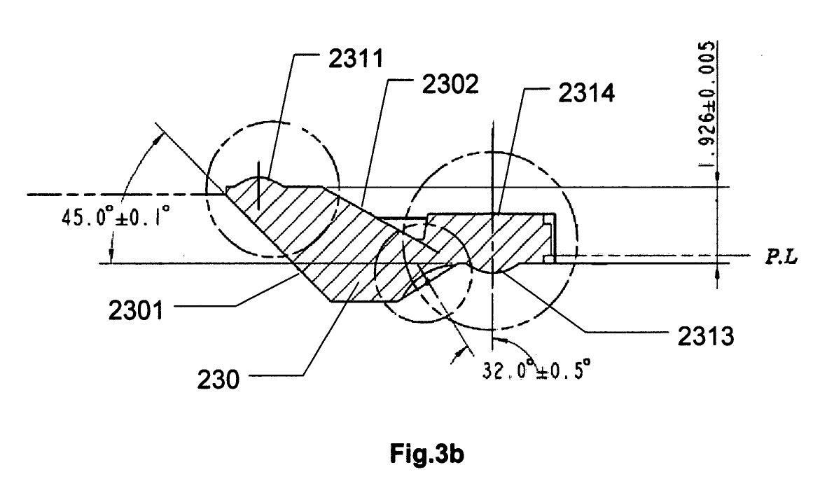

Please refer to FIG. 3a and FIG. 3b, which are diagrams illustrating an illumination guide for an optical computer mouse according to an embodiment of the present invention, with reference to FIG. 2a and FIG. 2b. The illumination guide 230 has a first reflector 2301 and a second reflector 2302. The illumination guide 230 further comprises a first surface 2311, a second surface 2312, a third surface 2313, and a fourth surface 2314. The illumination guide 230 further has a first mating surface 2321 and a second mating surface 2322.

The illumination guide 230 may be made of polymer, glass, or other refractive material which is substantially transparent to the wavelength of the illumination being used. Optically, the illumination beam 270 is emitted from the illumination source 240, enters the illumination guide 230 through the first surface 2311, is reflected from the first reflector 2301, is reflected from the second reflector 2302, and exits the illumination guide 230 through the second surface 2312.

The first surface 2311 is a convex surface that focuses the illumination beam 270 into a collimated light beam. The second surface 2312 is a concave surface which spreads the light exiting the illumination guide 230.

Optionally, to spread the illumination beam 270 more evenly, the first surface 2311 and second surface 2312 may be shaped, for example by stippling or otherwise hazing their surfaces. Optionally, to spread the scattered illumination from the reference surface 10 to the optical sensor 250 for the purpose of removing detail from the image formed on the optical sensor 250, the third surface 2313 may be textured. Please note that the first surface 2311, the third surface 2313, and/or the fourth surface may be flat surfaces in some embodiments.

Continuing with discussion of FIG. 3a and FIG. 3b, the illumination is scattered from the reference surface and re-enters the illumination guide 230 through the third lens 2313, and travels through the illumination guide 230 to the fourth lens 2314, where the illumination beam 270 then exits the illumination guide 230 to fall onto the optical sensor 250.

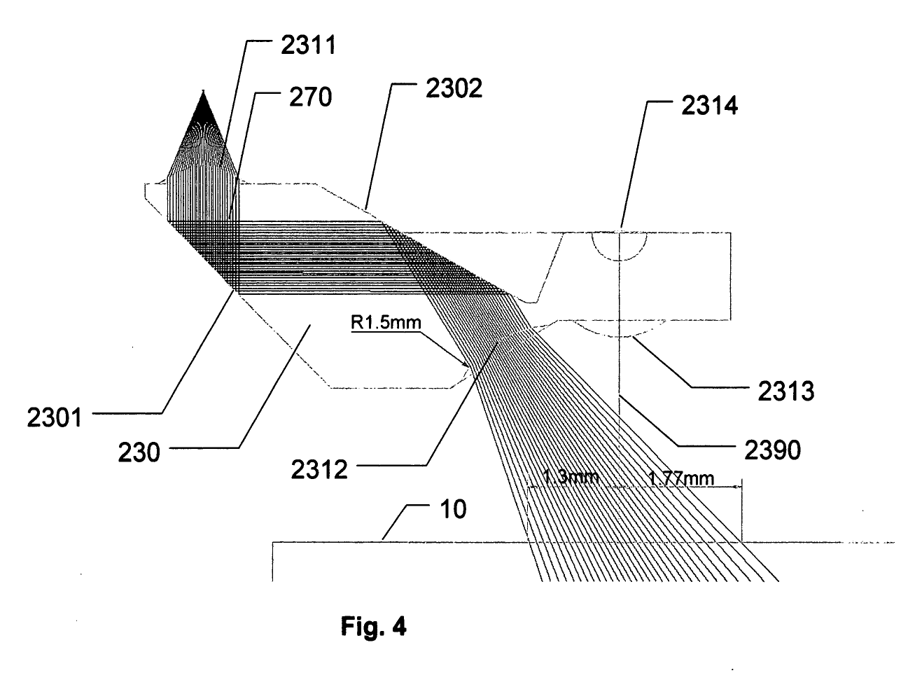

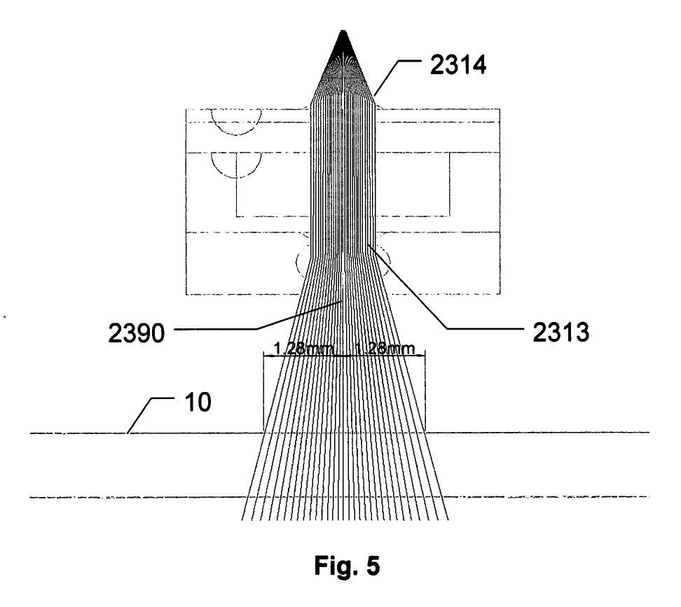

Refer to FIG. 4, which is a drawing illustrating the light path through the illumination guide according to an embodiment of the present invention and to FIG. 5, which is a drawing illustrating the light path into the illumination guide according to an embodiment of the present invention.

The illumination source illuminates the first surface 2311 of the illumination guide 230 with about sixty degrees of its output. The first surface 2311 is designed with the correct focal length to collimate this illumination into an illumination beam 270. Any illumination which is moving in other directions is scattered or absorbed by the holder (not shown), which is preferably made of a black nonreflective material such as a polymer.

The first reflector 2301 and second reflector 2302 reflect the illumination beam 270 through the second surface 2312, which spreads the illumination beam 270 substantially to illuminate the reference surface 10 through the main aperture. The second surface 2312 is a concave lens which spreads the light to create a uniform illumination pattern on the reference surface 10.

Illumination which is scattered from the reference surface 10 re-enters the illumination guide 230 through the third surface 2313, travels through the illumination guide 230, exits through the fourth surface 2314, and falls on the image plane of the optical sensor.

The length of the first reflector 2301 is the width of the exit aperture divided by the sine of forty-five degrees. The length of the second reflector 2302 is the same as the width of the exit aperture (since the first reflector 2301 was selected to be at a forty-five degree angle) divided by the sine of the quantity forty-five degrees minus half the angle of incidence from the normal. In an embodiment of the present invention, it was chosen to be thirty-two degrees which simplifies to the sine of twenty-nine degrees.

Referring back to FIG. 4, in an embodiment of the present invention, the radius of curvature of the concave lens 2312 is chosen to be 1.5 mm. As a result, the illumination pattern on the reference surface 10 extends 3.07 mm in width. From a reference line 2390 through the centerpoint of the third and fourth lenses, the illumination pattern is position from 1.3 mm in front of the reference line 2390 and 1.77 mm past the reference line 2390.

Referring back to FIG. 5, in an embodiment of the present invention, the light pattern reflecting off the reference surface 10, to be picked up by the third lens 2313, extends 1.28 mm outwards from the reference line 2390.

It should be noted that these values can be selected to meet design requirements. For example, depending on the distance of the light source or illumination guide to the reference surface, the illumination pattern can be larger or smaller. Also, the curvature of the concave lens can be designed to meet requirements.

In summary, the scattered light emitted from the light source is collected by the first lens which transforms the light into a collimated light beam. After reflecting off two reflective surfaces, the light is spread into a uniform light illumination pattern by the concave lens. This provides a low contrast uniform light pattern on the reference surface. This light reflects off the surface and enters the illumination guide through a third lens which focuses the light into a collimated light beam. The third lens acts substantially like the first lens. The light then exits the illumination guide via the fourth lens and falls on the sensor.

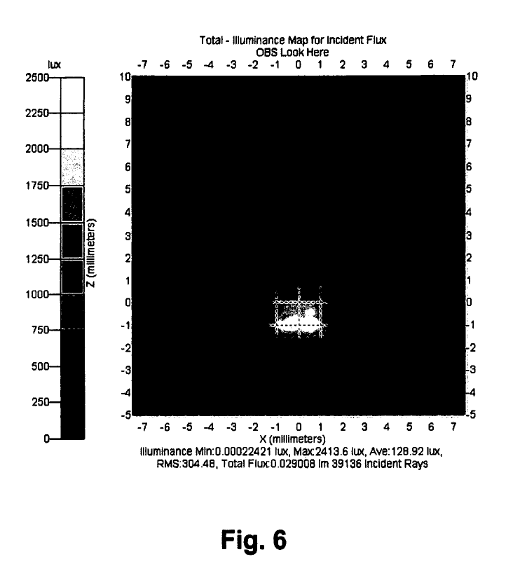

Refer to FIG. 6, which is a diagram illustrating an illuminance map of the optics for an optical mouse according to an embodiment of the present invention. As shown in FIG. 6, the light pattern provided by the optics system of the present invention is extremely uniform. This high quality light pattern improves the performance of the optical mouse by allowing the sensor to more accurately detect mouse movement. As a result, the quality and value of the optical mouse provided by the present invention is increased. In prior art designs, the illuminance map shows areas of extreme brightness and areas of little or no light. These prior art designs provide a light pattern that is not uniform. As a result, a prior art optical mouse does not provide accurate and smooth mouse movement information to the computer.

The optical mouse system of the present invention also provides a substantial improvement over the prior art by reducing power usage and materials costs, and by simplifying the internal construction of the optical mouse core. Isolation of the illumination source from the optical sensor, and of the optical sensor from external illumination, helps to increase sensitivity of the system. Furthermore, its smaller form factor gives designers more flexibility in housing design.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An optical mouse system comprising:
an illumination guide for guiding light from an illumination source to a sensor, comprising:
a first convex surface for receiving light from the illumination source and transforming the light into a first collimated light beam;
a second concave surface for spreading the first collimated light beam into a uniform illumination pattern onto a reference surface;
a third convex surface for receiving light reflected off the reference surface and transforming the light into a convergent light beam; and
a fourth convex surface for focusing the convergent light beam onto the sensor.

2. The optical mouse system of claim 1, further comprising:
a printed circuit board, having at least a first surface on which components are mounted; and
a sensor, having a sensing surface comprising an array of sensing elements, where a vector normal to the sensing surface and the illumination source is parallel to a vector normal to the first surface of the printed circuit board.

3. The optical mouse system of claim 1, wherein the illumination source comprises a light-emitting diode (LED), an infrared-emitting diode (IRED), or a laser diode (LD).

4. The optical mouse system of claim 1, the illumination guide further comprising a first reflector and a second reflector, where the first reflector is disposed at an angle substantially near forty-five degrees from a vector to the illumination source, and where the second reflector is disposed at an angle substantially near twenty-nine degrees from a reflection of the vector from the first reflector.

5. The optical mouse system of claim 4, where the first convex surface is disposed on a surface proximal to the illumination source and with an optical axis of the first convex lens substantially centered on and substantially parallel to an optical axis of the illumination source; the concave surface is disposed on a source exit surface and with an optical axis of the concave surface substantially centered in the illumination beam after the illumination beam reflects from the first reflector and then reflects from the second reflector, for spreading the illumination beam to illuminate the reference surface; and the second convex lens is disposed on an illumination entry surface and with an optical axis of the third lens substantially centered on and substantially parallel to a normal vector directed from a center of the sensing surface.

6. The optical mouse system of claim 1, where a radius of curvature of the concave lens is 1.5 mm.

7. The optical mouse system of claim 1, where the illumination guide further comprises shapes on a surface of the first convex surface and on a surface of the second concave surface, to remove artifacts in the illumination beam.

8. The optical mouse system of claim 1, where the illumination guide further comprises texturing on a surface of the second convex lens.

9. An optical mouse system comprising:
a printed circuit board, having at least a first surface on which components are mounted;
an illumination source where an axis of the illumination source is parallel to a vector normal to the first surface of the printed circuit board;
a sensor, having a sensing surface comprising an array of sensing elements, where a vector normal to the sensing surface is parallel to a vector normal to the first surface of the printed circuit board;
an illumination guide, for directing illumination from the illumination source to a reference surface and for redirecting scattered illumination from said reference surface toward the sensing surface of the sensor, the illumination guide comprising:
a first convex surface for receiving light from the illumination source and transforming the light into a first collimated light beam; and
a second concave surface for spreading the first collimated light beam into a uniform illumination pattern onto a reference surface; and
a holder shaped to fit over the illumination source and the sensor.

10. The optical mouse system of claim 9, the illumination guide further comprising:
a third convex surface for receiving light reflected off the reference surface and transforming the light into a convergent light beam.

11. The optical mouse system of claim 10, the illumination guide further comprising:
a fourth convex surface for focusing the convergent light beam onto the sensor.

12. The optical mouse system of claim 9, the illumination guide further comprising a first reflector and a second reflector.

13. The optical mouse system of claim 12, where the first reflector is disposed at an angle substantially near forty-five degrees from a vector to the illumination source, and where the second reflector is disposed at an angle substantially near twenty-nine degrees from a reflection of the vector from the first reflector.

14. The optical mouse system of claim 10, where the first convex lens is disposed on a surface proximal to the illumination source and with an optical axis of the first convex lens substantially centered on and substantially parallel to an optical axis of the illumination source; the concave surface is disposed on a source exit surface and with an optical axis of the concave lens substantially centered in the illumination beam after the illumination beam reflects from the first reflector and then reflects from the second reflector, for spreading the illumination beam to illuminate the reference surface; and the second convex lens is disposed on an illumination entry surface and with an optical axis of the third lens substantially centered on and substantially parallel to a normal vector directed from a center of the sensing surface.

15. The optical mouse system of claim 11, where the third convex lens is disposed on the illumination guide where the illumination beam exits the illumination guide to fall onto the sensor.

16. The optical mouse system of claim 9 where the illumination guide further comprises texturing on a surface of the first convex lens and a surface of the concave lens to spread the illumination beam.

17. The optical mouse system of claim 9 further comprising a housing having a bottom surface shaped to move against the reference surface and a top surface, said housing containing the holder, the illumination guide, the printed circuit board, the illumination source, and the sensor within the housing.

18. The optical mouse system of claim 9 where the illumination source comprises a light-emitting diode (LED), an infrared-emitting diode (IRED), or a laser diode (LD).

19. An optical mouse system comprising:
a printed circuit board, having at least a first surface on which components are mounted;
an illumination source for providing light;
a sensor for detecting light; and
an illumination guide for directing illumination from the illumination source to a reference surface and for redirecting scattered illumination from said reference surface toward the sensor, the illumination guide comprising:
a first convex surface for receiving light from the illumination source and transforming the light into a first collimated light beam; and
a concave surface for spreading the first collimated light beam into a uniform illumination pattern onto the reference surface.

20. The optical mouse system of claim 19, the illumination guide further comprising:
a third convex surface for receiving light reflected off the reference surface and transforming the light into a convergent light beam; and
a fourth convex surface for focusing the convergent light beam onto the sensor.
